(19) United States
(12) Patent Application Publication
(10) Pub. No.: US 2015/0108288 A1
(43) Pub. Date: Apr. 23, 2015

(54) PIPE CLAMP

(71) Applicant: GOODSENSE CO., LTD., Goyang-si (KR)

(72) Inventor: Kye-Yoon Lee, Goyang-si (KR)

(21) Appl. No.: 14/384,411

(22) PCT Filed: Mar. 12, 2013
(86) PCT No.: PCT/KR2013/001976

§ 371 Date: Sep. 11, 2014

(30) Foreign Application Priority Data
Mar. 22, 2012 (KR) 10-2012-0029483
Oct. 10, 2012 (KR) 20-2012-0009078

(51) Int. Cl. F16B 7/04; F16L 3/02

(52) U.S. Cl. CPC F16B 7/0493; F16L 3/02
USPC 248/68.1; 248/219.4; 248/72

(57) ABSTRACT

The present invention relates to a pipe clamp, more specifically to a pipe clamp having a first coupling frame, a second coupling frame, a connecting element, and a tightly contacting lever connected rotatably to each other and structured so as to surround the pipe one and a half times around, that is, 540 degrees, and, because the tightly contacting lever tightly adheres simultaneously to the outer circumferential surface of the first coupling frame, the pipe clamp having a superior pipe holding force and additionally preventing completely the possibility of having the clamp spontaneously open without the intention of a user.

### TECHNICAL FIELD

The present invention relates to a pipe clamp, more specifically to a pipe clamp composed of No. 1 coupling frame, No. 2 coupling frame, a connecting member and a contact lever, connected rotatably to each other to surround the said pipe by one and a half turns or by 540 degrees. At the same time, the said contact lever adheres tightly to the outer circumferential surface of the said No. 1 coupling frame, and so the force of grasping the said pipe is excellent and the pipe clamp can never open by itself regardless of the intention of users.

### TECHNICAL BACKGROUND

In general, clamps are used in case of fixing 2 or 3 pipes crossing each other or installing shelves on pipes. Depending on the method of tightening clamps to pipes, such clamps are divided into screw type and lever type. In general, the screw type has a strong holding power but has a shortcoming that the installation method is somewhat inconvenient. On the contrary, the lever type has a simple installation method but a somewhat weak holding power.

Attached FIG. 1 shows the shelf-fixing equipment introduced as an example of conventional lever-type clamps in Korean Disclosed Utility Model No. 20-2009-7325. The said shelf-fixing equipment is characteristic in that it consists of the solid part (100), on the inner surface of which No. 1 fixing groove (120) is formed to wrap a part of the outer surface of the support (20), and on the outer surface of which the bended surface (110) is formed to fix the shelf frame (15); the opening/closing part, on the inner surface of which No. 2 fixing groove (210) is formed to wrap the rest of the part for outer surface of the said support (20), and on the outer surface of which the protruded jaw (220) is formed for rotatable connection to the said main body part (100); and the fixing part (300) composed of the fixing handle (310) to fix the opening/closing part (200) while inserted into the said protruded jaw (220) and the handle connection part (320) connected rotatably to each of the said fixing handle (310) and the said main body (100).

The installation method of this shelf-fixing equipment is to tighten the said main body part (100) and opening/closing part (220) while the hitch part (314) of the fixing handle (310) sits on the dent part (220a) of the protruded jaws (220) if the fixing handle is rotated, after inserting the handle connection part (320) between the protruded jaws (220) while the outer circumferential surface of the support (20) is wrapped with the said main body part (100) and opening/closing part (200). At this time, the said hitch part (314) forms an eccentric structure, and the grasping force of the said main body part (100) and the opening/closing part (200) is proportional to the eccentric distance of the said hitch part (314).

Since in the shelf-fixing equipment with such a structure, the fixing handle (310) is protruded, as shown in FIG. 1, out of the opening/closing part (200) while installed to the support (20), however, other objects are likely to be hung on the fixing handle (310) during the use and then, the main body part (100) and the opening/closing part (200) are highly likely to open to each other while the said fixing handle (310) tilts regardless of the intention of users.

In addition, since the said main body part (100) and opening/closing part (200) are supported only by the contact with the hitch part (314) and protruded jaws (220) of the fixing handle (310), the overall tightening structure is very weak. Thus, if the eccentric distance of the said hitch part (314) is increased to improve the grasping force of the said support (20), a strong repulsive force is created between the said main body part (100) and the opening/closing part (200). Therefore, if repeated impacts are imposed during the use, the fixing handle (310) loosens little by little, and then finally, the main body part (100) and the opening/closing part (200) are likely to open to each other by themselves.

### DETAILED DESCRIPTION OF INVENTION

### Technical Task

Thus, the task to be solved by the present design is to provide clamps with a new structure which are never likely to be opened regardless of the intention of users by the external impacts imposed during the use of pipe clamps and at the same time have a strong grasping force for pipes.

### Means For Solution of Task

The pipe clamp based on the present design is characteristic in that it is composed of No. 1 coupling frame, No. 2 coupling frame, a connecting member, a contact lever, and others connected to make each other to rotate.

The said No. 1 coupling frame has a half-cylindrical structure adhered to the outer circumferential of the circular pipe (P) and is characteristic in that an elastic packing is attached to the inner circumferential surface and a pair of obstacle parts are formed on the left side.

The said No. 2 coupling frame has a half-cylindrical structure to surround the said pipe (P) in connection to the said No. 1 coupling frame and is characteristic in that the left side is connected rotatably to the right side of the said No. 1 coupling frame by No. 1 hinge pin (H1) and an elastic packing is attached to the inner circumferential surface.

The said connecting member is characteristic in that the left end is connected rotatably to the right side of the said No. 2 coupling frame by No. 2 hinge pin (H2) and the right end is inserted between both obstacle parts of the said No. 1 coupling frame.

The said contact lever has a circular-arc tabular structure to surround the said pipe (P) by a half turn more in adherence to the outer circumferential surface of the said No. 1 coupling frame and is characteristic in that on the left side, formed is an axial support part with an eccentric structure connected rotatably to the right end of the said connecting rod by No. 3 hinge pin (H3).

### Effects of Invention

In the pipe clamp based on the present design, the said contact lever has a circular-arc tabular structure and surrounds the said pipe (P) by a half turn more in adherence to the outer circumferential surface of the said No. 1 coupling frame. Thus, since the said No. 1 coupling frame. No. 2 coupling frame, connecting member, and contact lever at the state of connection to each other surround the pipe (P) by one and a half turns or 540 degrees, the pipe clamp of the present invention is effective in improving the grasping force for the pipe (P) in comparison with conventional lever-type clamps.

In addition, since the said contact lever is adhered to or dented into the outer circumferential surface of the said No. 1 coupling frame, the pipe clamp of the present invention is effective in that it is never likely to open by itself due to the hanging or repeated impacts of the said contact lever created by other objects during the process of its use.

### BRIEF DESCRIPTION OF DRAWINGS

FIG. 1 shows the perspective drawing of a conventional lever-type clamp.

FIG. 2 shows the front (a) and rear (b) perspective drawings of the cramp for the first Example of the present design.

FIG. 3 shows the unfolded perspective drawing of the clamp in the said FIG. 2.

FIG. 4 shows the cross section of the unfolded (a) and folded (b) clamp in the said FIG. 2.

FIG. 5 shows the service-state diagram of the clamp in the said FIG. 2.

FIG. 6 shows the perspective drawing (a) and service-state diagram (b) of the clamp for the second Example of the present design.

FIG. 7 shows the perspective drawing (a) and service-state diagram (b) of the clamp for the third Example of the present design.

FIG. 8 shows the perspective drawing (a) and service-state diagram (b) of the clamp for the fourth Example of the present design.

FIG. 9 shows the perspective drawing (a) and service-state diagram (b) of the clamp for the fifth Example of the present design.

### EXPLANATION OF SIGNS FOR MAJOR PARTS IN DRAWINGS

10; No. 1 Coupling Frame, 11,21; Elastic Packing

12; Obstacle Part, 13; Lever Accommodation Groove

14; Wire Installation Part, 15; Pipe Support Part

20; No. 2 Coupling Frame, 22; Reinforcing Lib

23; Wire Insertion Groove, 24; Pipe Insertion Conduit

25; Hanging Rod, 26; Pipe Hanging Part

30; Connecting Member, 40; Contact Lever

41; Axial Support Part, 42; Handle Groove

H1,H2,H3; Hinge Pin, P,P1,P2,P3; Pipe

Y1,Y2; Wire

### THE BEST FORMS FOR IMPLEMENTATION OF INVENTION

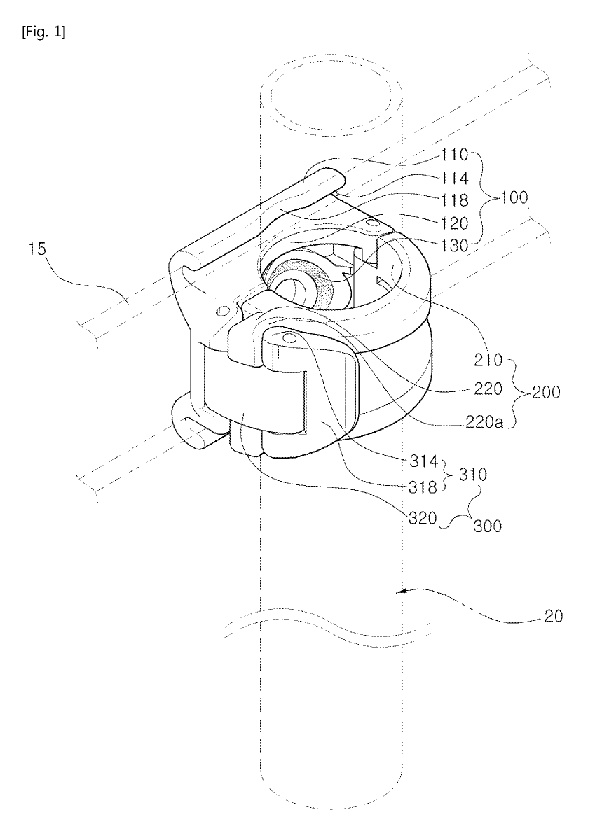

Hereunder, the present design is described in detail by using attached drawings. For reference, regardless of the conventional technology introduced in FIG. 1, independent names and drawing numbers are assigned to the clamp of the present design and detailed explanation is omitted for self-evident structures of the conventional technology.

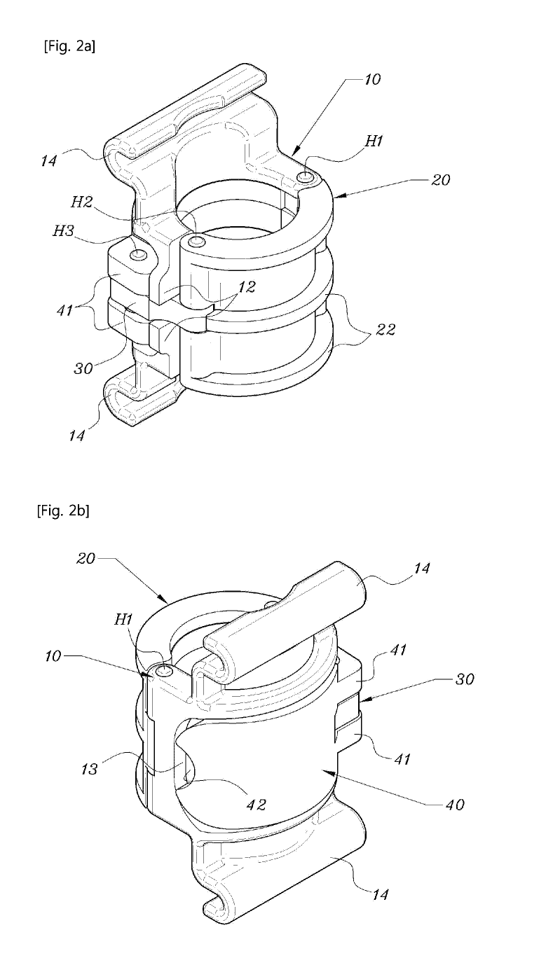

In addition, in the present design, in case of components with the same functions, the same drawing number is assigned in spite of different Examples, and for convenience, the present design is classified for explanation into ‘Top End’ and ‘Bottom End’ on the basis of the direction of FIG. 2. And out of both sides opposing each other, any one side is designated as ‘Left Side’ and the other as ‘Right Side’. Thus, it is all right to exchange ‘Left Side’ and ‘Right Side’.

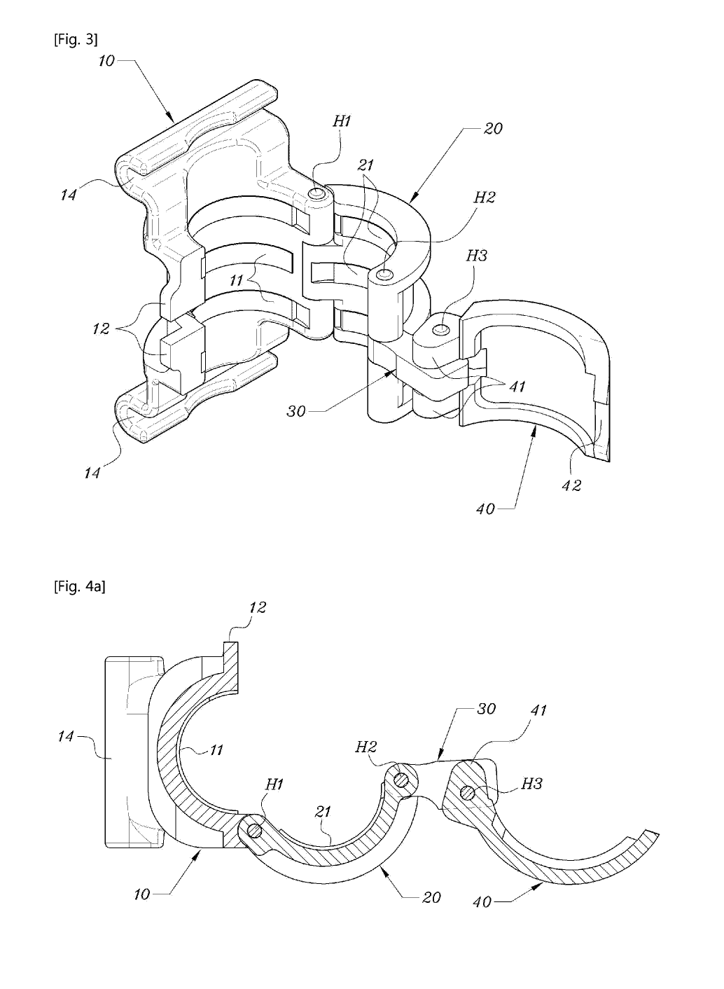

The pipe clamp based on the present design consists, as shown in FIGS. 2 and 3, of No. 1 coupling frame (10), No. 2 coupling frame (20), the connecting member (30), and the contact lever (40).

First of all, No. 1 coupling frame (10) has a half-cylindrical structure adhered to the outer circumferential surface of the circular pipe (P) and has an elastic packing attached to the inner circumferential surface in contact with the circular pipe (P). And, in the said No. 1 coupling frame (10), a pair of obstacle parts (12) is formed on the left side out of both sides formed in the length direction of the said pipe (P).

Next, No. 2 coupling frame (20) has a half-cylindrical structure to surround the said pipe (P) by one turn in combination with No. 1 coupling frame (10) and has an elastic packing (21) attached to the inner circumferential surface in contact with the said pipe (P). And, on the right side of the said No. 1 coupling frame, or between the opposite side of the said obstacle part (12) and the left side of No. 2 coupling frame (20), installed is No. 1 hinge pin (H1) connected to enable both sides to rotate. On the outer circumferential surface of the said No, 2 coupling frame (20), installed is the reinforcing lib (22) to improve the supporting power in the direction of circumference.

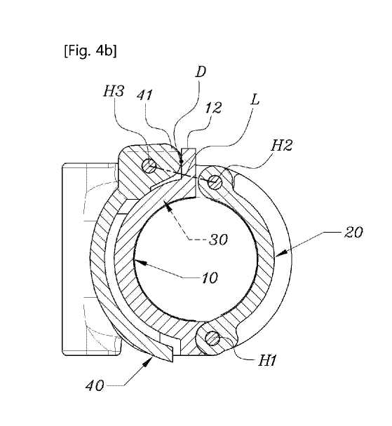

The said connecting member (30) connects, as shown in FIG. 4a, No. 2 housing (20) and the cover member (40), and the left end of the said connecting member (30) is connected rotatably to the right side of No. 2 coupling frame (20) by No. 2 hinge pin (H2).

And, if the clamp of the present design is folded, as shown in FIG. 4b, the right end of the said connecting member (30) is inserted and protruded between both obstacle parts (12) of No. 1 coupling frame (10).

Finally, the contact lever (40) has a circular-arc tabular structure to surround the said pipe (p) by a half turn more in adherence to the outer circumferential surface of the said No. 1 coupling frame (10), and on the left side, the axial support part (41) is formed to connect rotatably to the right end of the said connecting rod (30) by No. 3 hinge pin (H3).

At this time, the said axial support part (41) has an eccentric structure for the said No. 3 hinge pin (H3). Thus, if the said cover member (40) is folded, as shown in FIG. 4b, the eccentric distance gets larger while the axial support part (41) rotates in adherence to the obstacle part (12). By the tensile force of the connecting rod (30) generated during this process, strongly adhered to the pipe (p) are No. 1 coupling frame (10) and No. 2 coupling frame (20).

Each elastic packing (11,21) attached to the inner circumferential surface of the said No. 1 coupling frame (10) and No. 2 coupling frame (20) has the function of improving the grasping force by accommodating the deviation between the inside diameter of the said coupling frames (10,20) and the outside diameter of the said pipe (P).

The present design is, as shown in FIG. 2b, equipped with the lever accommodation groove (13) into which the contact lever (40) is inserted on the outer circumferential surface of the said No. 1 coupling frame (10), and on the right side of the said contact lever (40), formed is the handle groove (41). In this way, since the said contact lever (40) is dented into the lever accommodation groove (13), the said contact lever (40) is not likely to be hung during the process of its use by other objects, and furthermore the clamp is never likely to open by itself as long as users do not open the contact lever (40) wide by using the said handle groove (41).

In addition, the structure for the clamp of the present design is characteristic in that when the said contact lever (40) is adhered to the outer circumferential surface of the said No. 1 coupling frame (10), as shown in FIG. 4b, the contact point (D) of the axial support part (41) and the obstacle part (12) is positioned outside the connection line (L) between the said No. 2 support pin (H2) and No. 3 support pin (H3). As explained earlier, if the said contact lever (40) is folded, a tensile force to attract each other between No. 2 support pin (H2) and No. 3 support pin (H3) is generated by the said connecting member (30). At this time, the contact point (D) of the axial support part (41) and the obstacle part (12) maintains the balance of force against the tensile force.

By the way, if the said contact point (D) is located on the said connection line (L), or inside the line, that is, on the side of the coupling frames (10, 20), the contact lever (40) may open easily even to small impacts. In the present design, however, since the said contact point (D) is positioned farther away than the said connection line (L) from the center of the circle composed of No. 1 coupling frame (10) and No. 2 coupling frame (20), the clamp maintains a very stable balance of force.

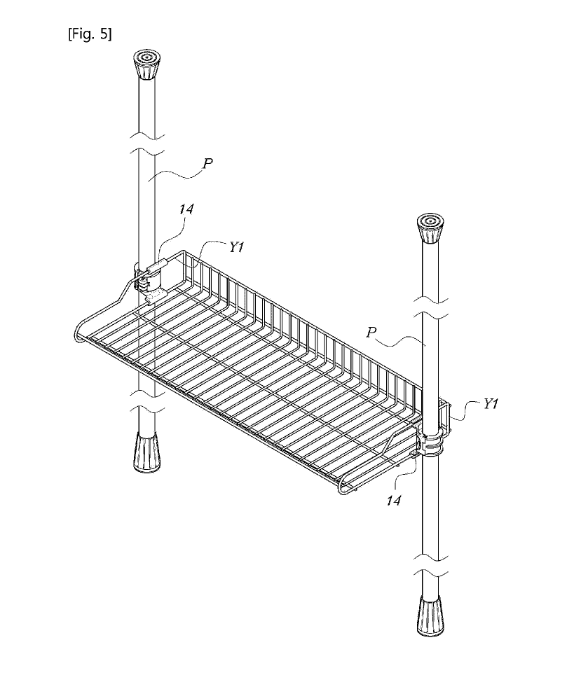

It is possible to apply to a variety of uses the pipe clamp of the present design with such a structure as mentioned above. First of all, the said FIG. 2 or FIG. 4 shows the structure in which, as the first Example of the present invention, each of the top and bottom ends of the said No. 1 coupling frame (10) is equipped with the wire installation part (14) bended in the form of ⊂ toward the said pipe (P). In the said first Example, as shown in FIG. 5, it is possible to install shelves by inserting into them the middle portion of the wire (Y1) crossing perpendicularly the said pipe (P).

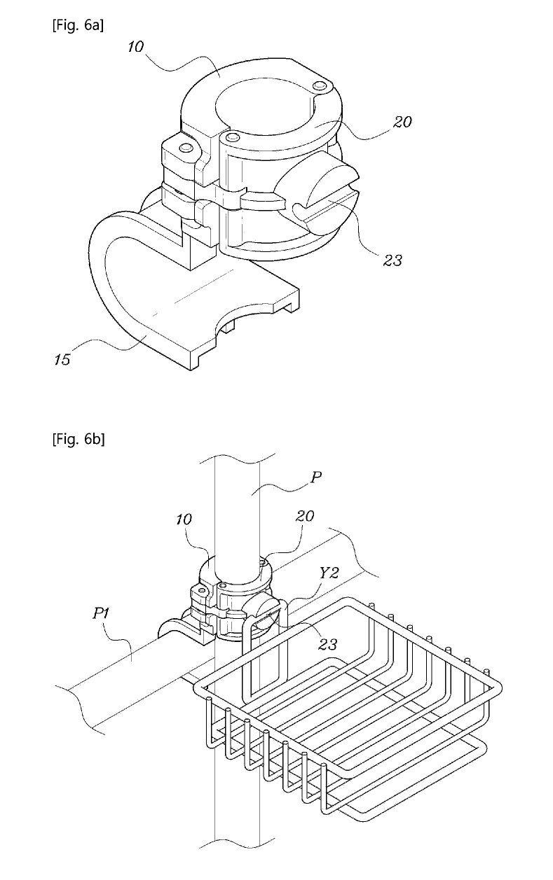

Next, FIG. 6a shows, as the second Example, the structure in which the bottom end of the said No. 1 coupling frame (10) is equipped with the pipe support part (15) bended in the form of ⊂ toward the said pipe (p) so as to support by insertion the middle portion of another pipe (p1) crossing perpendicularly the said pipe (P), and the outside surface of the said No. 2 coupling frame (20) is equipped with the wire insertion groove (23) to support by insertion the middle portion of the wire (Y2) in parallel with the said pipe (p1). FIG. 6b shows a commercial example of the said second Example.

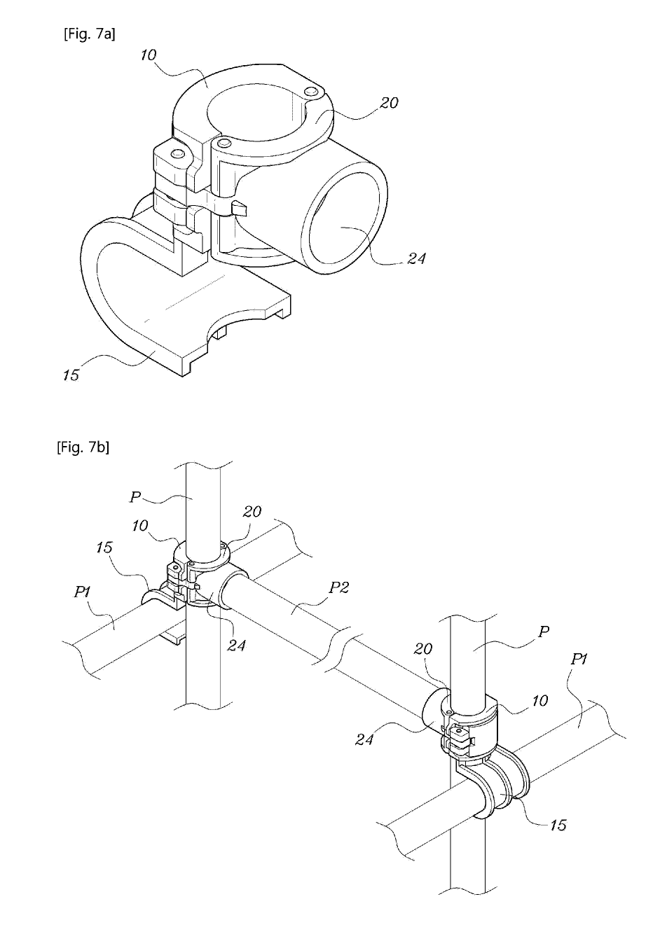

FIG. 7a shows, as the third Example, the structure in which the bottom end of the said No. 1 coupling frame (10) is equipped with the pipe support part (15) bended in the form of ⊂ toward the said pipe (p) so as to support by insertion the middle portion of another pipe (P1) crossing perpendicularly the said pipe (P), and the outside surface of the said No. 2 coupling frame (20) is equipped with the pipe insertion conduit (24) to insert the end of another pipe (p2) crossing perpendicularly each of the said pipe (P) and pipe (P1). The said third Example is used, as shown in FIG. 7b, in installing the three pipes (P, P1, P2) so that they may cross each other perpendicularly in the direction of X, Y, and Z axes.

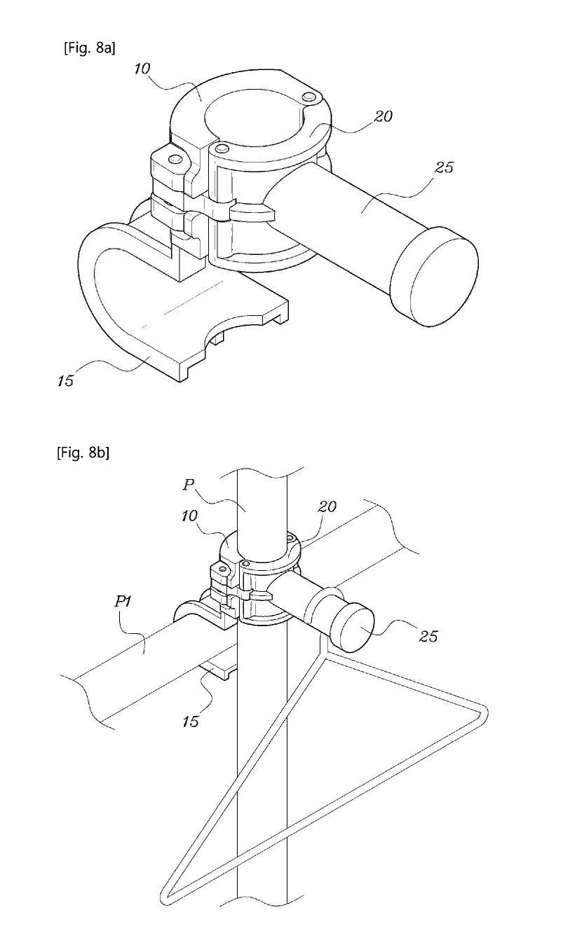

FIG. 8a shows, as the fourth Example, the structure in which the bottom end of the said No. 1 coupling frame (10) is equipped with the pipe support part (15) bended in the form of ⊂ toward the said pipe (p) so as to support by insertion the middle portion of another pipe (P1) crossing perpendicularly the said pipe (P), and on the outside surface of the said No. 2 coupling frame (20), the hanging rod (25) is protruded in the direction of crossing perpendicularly each of the said pipe (P) and pipe (P1). The hanging rod (25) of the said fourth Example is used, as shown in FIG. 8b, even in hanging clothes.

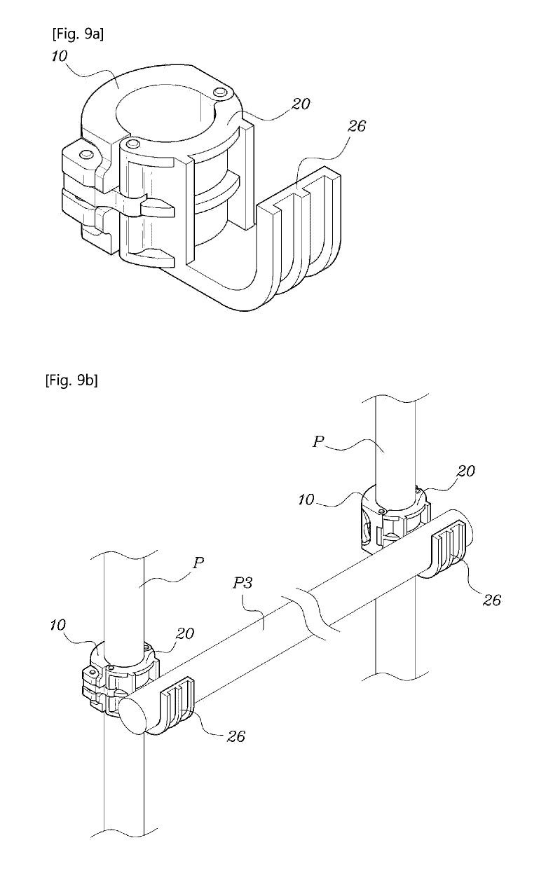

Finally, FIG. 9a shows, as the fifth Example, the structure in which the pipe hanging part (26) bended in the form of ∪ is protruded to put on the bottom end of the said No. 2 coupling frame (20) the pipe (p3) crossing perpendicularly the said pipe (P). The said fifth Example has, as shown in FIG. 9b, an advantage that the installation and removal of the pipe (P3) are easy.

1. A clamp used with a circular pipe, the clamp comprising:
a first coupling frame having a half-cylindrical structure shaped to adhered to an outer circumferential surface of the pipe, the first coupling frame having an elastic packing attached to an inner circumferential surface thereof and a pair of protrusions formed on a left side thereof;
a second coupling frame having a half-cylindrical structure shaped to be coupled with the first coupling frame to surround the pipe, a left side of the second coupling frame rotatably connected to a right side of the first coupling frame via a first hinge pin, the second coupling frame having an elastic packing attached to an inner circumferential surface thereof;
a connecting member having a left end portion rotatably connected to a right side of the second coupling frame via a second hinge pin and a right end portion inserted between both protrusions of the first coupling frame; and
a contact lever having a circular-arc tabular structure shaped to surround the pipe by an additional half turn by being adhered to the outer circumferential surface of the first coupling frame-, an axial support part having an eccentric structure formed on a left side of the contact lever to be connected rotatably to the right end portion of the connecting member via a third hinge pin.

2. The clamp according to claim 1, wherein: a lever reception groove is formed on the outer circumferential surface of the first coupling frame;
the contact lever is inserted into the lever reception groove; and
a handle groove is formed on a right side of the contact lever-.

3. The clamp according to claim 1, wherein a contact point of the axial support part and a protrusion is positioned outside a connection line that is formed between the second support pin and the third support pin, when the contact lever is adhered to the outer circumferential surface of the first coupling frame.

4. The clamp according to claim 1, wherein each of the top and bottom end portions of the said first coupling frame is equipped with a wire installation part that is bent in the form of ⊂ toward the pipe so as to support by insertion of a middle portion of a wire that crosses the pipe perpendicularly.

5. The clamp according to claim 1, wherein:
a bottom end portion of the first coupling frame is equipped with a pipe support part that is bent in the form of ⊂ toward the pipe so as to support by insertion of a middle portion of another pipe crossing the pipe perpendicularly; and
an outer surface of the second coupling frame is equipped with a wire insertion groove to support by insertion of a middle portion of a wire that is in parallel with said another pipe-.

6. The clamp according to claim 1, wherein:
a bottom end portion of the first coupling frame is equipped with a pipe support part that is bent in the form of ⊂ toward the pipe so as to support by insertion of a middle portion of a second pipe crossing the pipe perpendicularly; and
an outer surface of the second coupling frame is equipped with a pipe insertion conduit to insert an end portion of a third pipe crossing each of the pipe and second pipe.

7. The clamp according to claim 1, wherein:
a bottom end portion of the first coupling frame is equipped with a pipe support part that is bent in the form of ⊂ toward the pipe so as to support by insertion of a middle portion of another pipe crossing the pipe perpendicularly; and
a hanging rod is protruded on an outer surface of the second coupling frame in a direction crossing each of the pipe and said another pipe perpendicularly.

8. The clamp according to claim 1, wherein a pipe hanging part that is bent in the form of ∪ is protruded on a bottom end portion of the second coupling frame such that another pipe crossing the pipe perpendicularly is placed on the pipe hanging part.

9. The clamp according to claim 2, wherein a contact point of axial support part and a protrusion is positioned outside a connection line that is formed between the second support pin and the third support pin when the contact lever is adhered to the outer circumferential surface of the first coupling frame.

10. The pipe clamp according to claim 2, wherein each of top and bottom end portions of the first coupling frame is equipped with a wire installation part that is bent in the form of ⊂ toward the pipe so as to support by insertion of a middle portion of a wire that crosses the pipe perpendicularly.

11. The pipe clamp according to claim 2, wherein:
a bottom end portion of the first coupling frame is equipped with a pipe support part that is bent in the form of ⊂ toward the pipe so as to support by insertion of a middle portion of another pipe crossing the pipe perpendicularly; and
an outer surface of the second coupling frame is equipped with a wire insertion groove to support by insertion of a middle portion of a wire that is in parallel with said another pipe.

12. The pipe clamp according to claim 2, wherein:
a bottom end portion of the first coupling frame is equipped with a pipe support part that is bent in the form of ⊂ toward the pipe so as to support by insertion of a middle portion of a second pipe crossing the pipe perpendicularly; and
an outer surface of the second coupling frame is equipped with a pipe insertion conduit to insert an end portion of a third pipe crossing each of the pipe and second pipe.

13. The pipe clamp according to claim 2, wherein:
a bottom end portion of the first coupling frame is equipped with a pipe support part that is bent in the form of ⊂ toward the pipe so as to support by insertion of a middle portion of another pipe crossing the pipe perpendicularly; and
a hanging rod is protruded on an outer surface of the second coupling frame in a direction crossing each of the pipe and said another pipe perpendicularly.

14. The pipe clamp according to claim 2, wherein a pipe hanging part that is bent in the form of ∪ is protruded on a bottom end portion of the second coupling frame such that another pipe crossing the pipe perpendicularly is placed on the pipe hanging part.
